(19) United States
(12) Patent Application Publication
(10) Pub. No.: US 2026/0086417 A1
(43) Pub. Date: Mar. 26, 2026

(54) OPTICAL ASSEMBLY AND DISPLAY DEVICE

(71) Applicants: Asphetek Solution (Chengdu) Ltd., Chengdu (CN); Asphetek Solution Inc., Hsinchu (TW)

(72) Inventors: YUN-KAI HSU, Hsinchu (TW); Chung-Wu Liu, Hsinchu (TW)

(21) Appl. No.: 18/989,244

(22) Filed: Dec. 20, 2024

(30) Foreign Application Priority Data
Sep. 20, 2024 (CN) 202411318681.6

(51) Int. Cl. G02F 1/29; G06F 1/16

(52) U.S. Cl. CPC G02F 1/293; G06F 1/163

(57) ABSTRACT

The present application relates to the technical field of near-eye display devices, and aims to solve the problem of how to reduce the thickness of an optical component by providing an optical component and a display device. The optical assembly includes a display component and a refractive component. The display component has a display side, and the display component is capable of projecting imaging light toward the display side. The refractive component is disposed on the display side and adhered to the display component, and the refractive component is used to adjust a diopter of the imaging light. The beneficial effect of the present application is that by attaching the refractive component to the display component, the space between the refractive component and the display component is saved, and thereby the thickness of the optical component is reduced.

### FIELD

The subject matter relates to the technical field of near-eye display device, and in particular to an optical assembly and a display device.

### BACKGROUND

The related technology provides an optical assembly that includes a display component and a refractive component, the refractive component is used to adjust the refractive index of an imaging ray of the display component.

However, the optical assembly in the related technology has a large thickness.

### SUMMARY

The present application provides optical assembly and display device to solve the problem of how to reduce the thickness of an optical assembly.

According to an aspect of the present application, there is provided an optical assembly includes a display component and a refractive component. The display component has a display side, and the display component is capable of projecting imaging light rays to the display side. The refractive component is provided on the display side and adhered to the display component, and the refractive component is used to adjust a diopter of the imaging light.

The optical assembly described above, by attaching the refractive component to the display component, saves space between the refractive component and the display component, thereby reducing the thickness of the optical assembly.

In one embodiment, the refractive component is a liquid crystal lens, the liquid crystal lens includes a first substrate, a first electrode, a first liquid crystal layer, and a second electrode, the first substrate, the first electrode, the first liquid crystal layer, and the second electrode is disposed in a direction opposite to the projecting direction of the imaging light. The display component is an LCD, the LCD includes a color filter layer and a second liquid crystal layer, and the color filter layer is disposed on a side of the second liquid crystal layer near the display side. A side of the second electrode back from the first liquid crystal layer is adhered to the side of the color filter layer back from the second liquid crystal layer.

In one embodiment, the second electrode is affixed to the color filter layer by one of pasting, vaporizing, or sputtering.

In one embodiment, the refractive component is a liquid crystal lens, the liquid crystal lens includes a first substrate, a first electrode, a first liquid crystal layer, a second electrode, and a second substrate, the first substrate, the first electrode, the first liquid crystal layer, the second electrode, and the second substrate are disposed in a direction opposite to the projecting direction of the imaging light. The display component includes a third substrate, a color filter layer, and a second liquid crystal layer, the third substrate is disposed proximate to the display side, the color filter layer is disposed between the third substrate and the second liquid crystal layer. The optical component further includes an adhesive layer, the adhesive layer is disposed between the second substrate and the third substrate, and the second substrate is affixed to a side of the third substrate proximate to the display side by the adhesive layer.

In one embodiment, the adhesive layer includes an optically transparent adhesive or an optically transparent resin.

In one embodiment, the display component is one of an LCD, an OLED, and a Micro LED.

In one embodiment, the liquid crystal lens is one of a twisted-nematic type, a coplanar switching type, or a vertically oriented type.

In one embodiment, the difference between the dimensions of the display component and the dimensions of the refractive component in a direction perpendicular to the projecting direction of the imaging light is less than or equal to 76.2 mm.

In one embodiment, the optical assembly further includes a pancake lens and a linear polarizer. The pancake lens is disposed on a side of the refractive component away from the display component along a propagation direction of the imaging light. The linear polarizer is disposed between the pancake lens and the refractive component.

According to another aspect of the present application, there is provided a display device comprising an optical assembly as in any of the above embodiments.

### BRIEF DESCRIPTION OF THE DRAWINGS

FIG. 1 shows a schematic view of a display device according to an embodiment of the present disclosure.

FIG. 2 shows a schematic view of the optical assembly of FIG. 1.

FIG. 3 shows a schematic view of a first state of use of the liquid crystal lens of FIG. 1.

FIG. 4 shows a schematic view of a second state of use of the liquid crystal lens of FIG. 1.

FIG. 5 shows a schematic view of a third state of use of the liquid crystal lens of FIG. 1.

FIG. 6 shows a schematic structure of a display device according to another embodiment of the present disclosure.

### DETAILED DESCRIPTION

The technical solutions in the embodiments of the present application will be described clearly and completely in the following in conjunction with the accompanying drawings in the embodiments of the present application, and it is clear that the described embodiments are only a part of the embodiments of the present application and not all of the embodiments.

It should be noted that when an element is the to be “fixed” to another element, it may be directly on the other element or there may also be a centered element. When an element is the to be “attached” to another element, it may be directly attached to the other element or there may be both centered elements. When an element is considered to be “set on” another element, it may be set directly on the other element or there may be both centered elements. The terms “vertical,” “horizontal,” “left,” “right,” and similar expressions are used herein for illustrative purposes only. are used herein for illustrative purposes only.

Unless otherwise defined, all technical and scientific terms used herein have the same meaning as commonly understood by those skilled in the art belonging to the field of this application. Terms used herein in the specification of this application are used only for the purpose of describing specific embodiments and are not intended to limit this application. The term “or/and” as used herein includes any and all combinations of one or more related listed items.

Some embodiments of the present application are described in detail. The following embodiments and features in the embodiments may be combined with each other without conflict.

### Example of Implementation

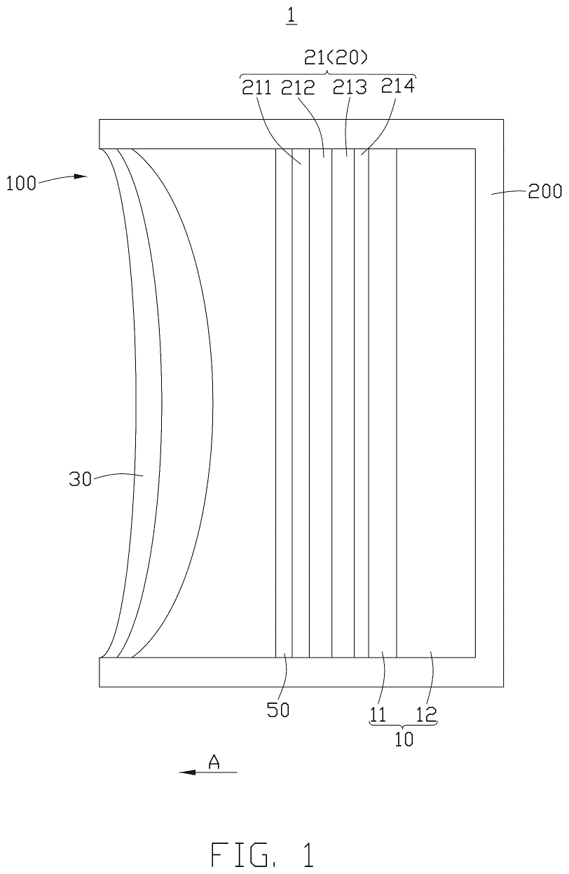

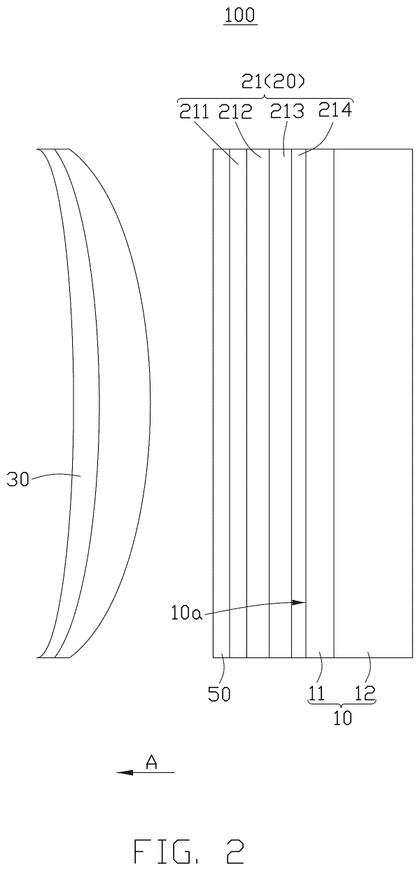

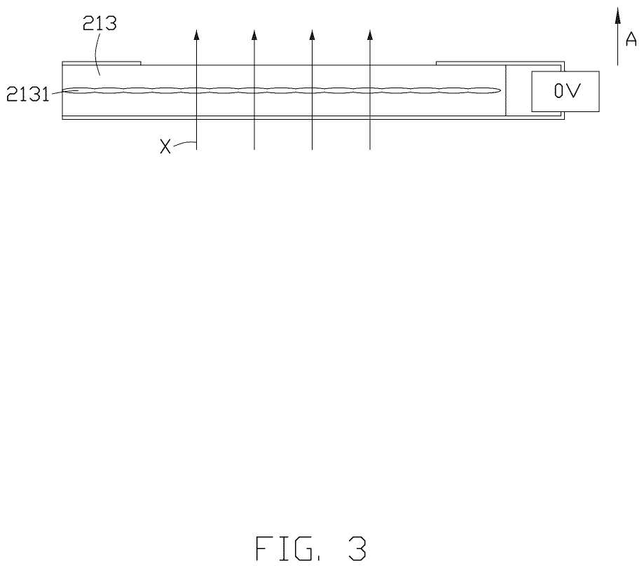

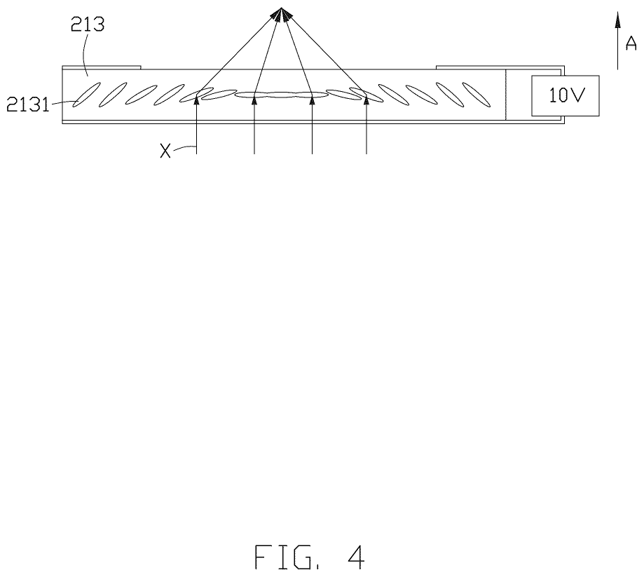

FIG. 1 shows a schematic structural view of a display device 1 in an embodiment of the present application; FIG. 2 shows a schematic structural view of an optical assembly 100 in the embodiment shown in FIG. 1; FIG. 3 shows a schematic view of a first use state of a liquid crystal lens 21 in the embodiment shown in FIG. 1; and FIG. 4 shows a schematic view of a second use state of the liquid crystal lens 21 in the embodiment shown in FIG. 1.

Referring to FIG. 1, an embodiment of the present application provides a display device 1 includes an optical assembly 100. The display device 1 is, for example, a VR (Virtual Reality technology) headset includes VR glasses or a VR helmet, etc., which is not limited herein.

In some embodiments, the display device 1 further includes a housing 200 in which the optical assembly 100 is mounted. Optionally, the housing 200 is made of one of Acrylonitrile Butadiene Styrene plastic (ABS plastic), polypropylene (PP), Polystyrene (PS), and Polycarbonate (PC).

The optical assembly 100 includes a display component 10 and a refractive component 20, and the cross-section of the housing 200 may be constructed to be circular, elliptical, rectangular, square, or otherwise irregularly shaped in a plane perpendicular to the projecting direction A of the imaging light ray X (see FIG. 3) of the display component 10.

Referring to FIG. 2, the optical assembly 100 provided in an embodiment of the present application includes the display component 10 and the refractive member 20. The display component 10 has a display side 10a, and the display component 10 is capable of projecting an imaging light ray X (see FIG. 3) to the display side 10a. The refractive component 20 is provided on the display side 10a and is affixed to the display component 10, and the refractive component 20 is used to adjust a diopter of the imaging ray X, as shown in conjunction with FIG. 3 and FIG. 4.

The above optical assembly 100, by providing the refractive component 20 at the display side 10a to adjust the refractive power of the imaging ray X, enables the refractive power to be adapted to the different degrees of myopia of the user without the need for additional myopic lenses in the optical assembly 100, and therefore can reduce the thickness of the optical assembly 100, and there is no need to externally or manually adjust the myopic lenses when using the optical assembly 100, which improves the convenience of using the optical assembly 100. Since the size of the refractive power can be adjusted by the refractive component 20, the optical assembly 100 can be suitable for most users with myopia or astigmatism, and there is no need to acquire myopic lenses again when replacing a user with a different degree of myopia. By attaching the refractive component 20 to the display component 10, the space between the refractive component 20 and the display component 10 is saved, thereby further reducing the thickness of the optical assembly 100.

It should be noted that, the thickness direction of the optical assembly 100 is the propagation direction A of the imaging ray X.

In some embodiments, as shown in FIG. 2, the refractive component 20 is a liquid crystal lens 21, the liquid crystal lens 21 includes a first substrate 211, a first electrode 212, a first liquid crystal layer 213, and a second electrode 214. The first substrate 211, the first electrode 212, the first liquid crystal layer 213, and the second electrode 214 is disposed in the direction opposite to the propagation direction A of the imaging light ray X. The display component 10 is an Liquid Crystal Display (LCD) , and the LCD includes a color filter layer 11 and a second liquid crystal layer 12, and the color filter layer 11 is disposed on a side of the second liquid crystal layer 12 near the display side 10a. The second electrode 214 is affixed to the side of the color filter layer 11 back from the first liquid crystal layer 213 on the side of the color filter layer 11 back from the second liquid crystal layer 12. Wherein, the LCD may be one of a twisted-nematic type (TN), a coplanar switching type (IPS), or a vertically oriented type (VA).

In this manner, by attaching the side of the second electrode 214 back from the first liquid crystal layer 213 to the side of the color filter layer 11 back from the second liquid crystal layer 12, there is no need to set up a substrate on the side of the second electrode 214 back from the first liquid crystal layer 213 in the liquid crystal lens 21, and there is no need to set up a substrate on the side of the color filter layer 11 back from the second liquid crystal layer 12 in the LCD, and thus at least the thicknesses of the substrates of the two layers can be saved, thereby further reducing the thickness of the optical assembly 100. Specifically, the thickness of the optical assembly 100 is from 5 mm to 50 mm. Therein, the thickness of the liquid crystal lens 21 is 0.5 mm to 50 mm in the direction A along which the imaging ray X propagates.

Referring to FIG. 4, in use, a voltage (e.g., a voltage of 10V) is applied to the first electrode 212 and the second electrode 214 (see FIG. 2), and the resulting electric field deflects the liquid crystal molecules 2131 in the first liquid crystal layer 213, thereby enabling, by changing the alignment direction of the liquid crystal molecules 2131 of the various portions of the first liquid crystal layer 213, to make the various portions of the first liquid crystal layer 213 have a different refractive indices. As shown in FIG. 3, when the first electrode 212 and the second electrode 214 are not applied with a voltage (i.e., the voltage is 0V), the liquid crystal molecules 2131 in the first liquid crystal layer 213 are not deflected. As shown in FIG. 4, when a voltage is applied to the first electrode 212 and the second electrode 214, a non-uniform electric field may be applied to the uniform first liquid crystal layer 213 to produce a gradient refractive index, e.g., a voltage may be applied to a portion of the first liquid crystal layer 213 other than the center portion thereof via the first electrode 212 and the second electrode 214, so that the imaging ray X passing through the first liquid crystal layer 213 can be effectively tilted, so that the output wavefront can be focused for imaging at a focal point, thereby making it suitable for a myopic user.

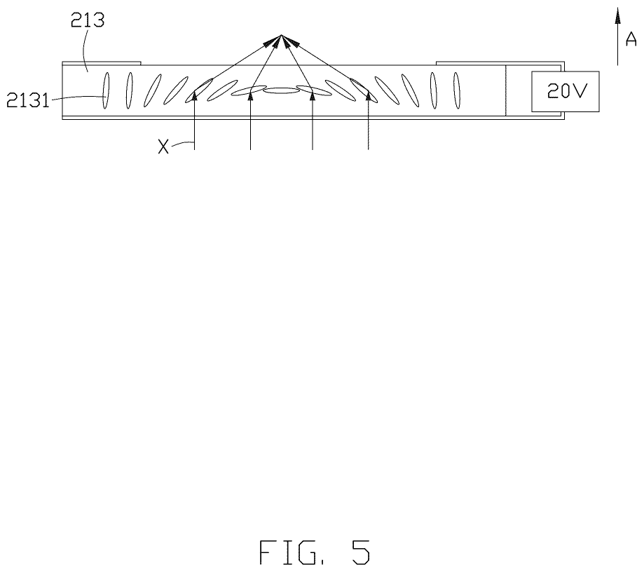

FIG. 5 shows a schematic view of a third state of use of the liquid crystal lens 21 of the embodiment shown in FIG. 1.

By changing the magnitude of the voltage applied to the first electrode 212 and the second electrode 214, it is possible to change the refractive power of the imaging ray X, so as to be adapted to different degrees of myopia of the user. For example, as shown in FIG. 5, when a larger voltage is applied to the first electrode 212 and the second electrode 214, such as when the voltage is changed from 10 V in FIG. 4 to 20 V, the alignment direction of the liquid crystal molecules 2131 in the portion other than the center portion of the first liquid crystal layer 213 is deflected by a larger amount, so that the inclination of the imaging ray X passing through the portion other than the center portion of the first liquid crystal layer 213 is further increased.

In some embodiments, the second electrode 214 is affixed to the color filter layer 11 by one of pasting, vaporizing, or sputtering.

In some embodiments, the liquid crystal lens 21 is one of a twisted-nematic (TN) type, a coplanar switching (IPS) type, or a vertically oriented (VA) type. Optionally, in a plane perpendicular to the propagation direction A of the imaging ray X, the cross-section of the liquid crystal lens 21 is constructed to be in the shape of a circle, an ellipse, a rectangle, a square, or other irregular shape.

In some embodiments, in a direction perpendicular to the propagation direction A of the imaging ray X, the dimensions of the refractive component 20 are constructed to fit the dimensions of the display component 10, and the dimensions of the display component 10 are not limited herein. Specifically, in the direction perpendicular to the propagation direction A of the imaging ray X, the dimensions of the display component 10 may be greater than, or equal to, or smaller than the dimensions of the refractive component 20. Optionally, in the direction perpendicular to the propagation direction A of the imaging ray X, the difference between the dimensions of the display component 10 and the dimensions of the refractive component 20 is less than or equal to 76.2 mm.

In some embodiments, as shown in FIG. 2, the optical assembly 100 further includes a pancake lens 30 and a linear polarizer 50. Along the propagation direction A of the imaging light ray X, the pancake lens 30 is provided on a side of the refractive component 20 away from the display component 10, and the linear polarizer 50 is provided between the pancake lens 30 and the refractive component 20. In this manner, the pancake lens 30 is provided, so as to reduce the distance between the display component 10 and the pancake lens 30 along the propagation direction A of the imaging light ray X by the design of the collapsed optical path, which is conducive to further reducing the thickness of the optical assembly 100. Optionally, the pancake lens 30 is spaced apart from the refractive component 20 in the propagation direction A along the imaging ray X. Therein, the distance between the pancake lens 30 and the refractive component 20 is set according to the need for use and is not limited herein. The number of stacked layers and the number of optically functional layers of the pancake lens 30 are not limited herein.

Optionally, the pancake lens 30 is made from an optical lens material such as glass, cyclic olefin copolymer (COC), Polymethyl Methacrylate (PMMA) or Polycarbonate (PC).

In some embodiments, the pancake lens 30 has a refractive index of 1. 4 to 2. 0, e.g., 1.4, 1.5, 1.7, 2.0, and the like.

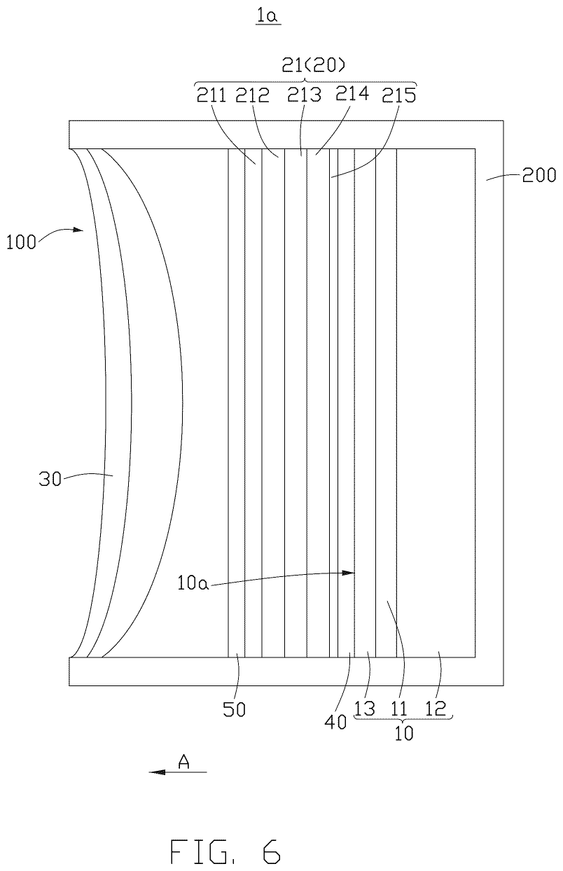

FIG. 6 shows a schematic structural view of a display device 1a in another embodiment of the present application.

Referring to FIG. 6, the display device 1a in Example 2 is substantially the same as the display device 1 of Example 1, with the difference that, in the display device 1a, the liquid crystal lens 21 further includes a second substrate 215. Along the propagation direction A of the imaging light ray X, the second substrate 215 is disposed on the side where the second electrode 214 is backed away from the first liquid crystal layer 213. The display component 10 further includes a third substrate 13, the third substrate 13 is disposed proximate the display side 10a, and the color filter layer 11 is disposed between the third substrate 13 and the second liquid crystal layer 12. The optical component 100 further includes an adhesive layer 40, the adhesive layer 40 is disposed between the second substrate 215 and the third substrate 13, the second substrate 215 is affixed to the side of the third substrate 13 proximate to the display side 10a by the adhesive layer 40, thereby reducing the space between the second substrate 215 and the third substrate 13, so that the thickness of the optical component 100 is reduced. For example, the optical assembly 100 has a thickness of 10 mm to 50 mm.

The display component 10 in this embodiment may be one of LCD, Organic Light-Emitting Diode (OLED), and Micro Light Emitting Diode (Micro LED).

The adhesive layer 40 in this embodiment may be an optically clear adhesive (OCA) or an optically clear resin (OCR), or it may be another type of bonding material.

The above embodiments are only used to illustrate the technical solutions of the present application and are not intended to be limiting, although the application has been described in detail with reference to the above preferred embodiments, a person of ordinary skill in the art should understand that modifications or equivalent substitutions can be made to the technical solutions of the present application without departing from the spirit and scope of the technical solutions of the present application.

What is claimed is:

1. An optical assembly comprising:
a display component having a display side, the display component configured to project imaging light to the display side; and
a refractive component provided on the display side of the display component and affixed to the display component, the refractive component being configured to adjust a refractive index of the imaging light projected by the display component.

2. The optical assembly of claim 1, wherein the refractive component is a liquid crystal lens, the liquid crystal lens comprises a first substrate, a first electrode, a first liquid crystal layer and a second electrode;
the first substrate, the first electrode, the first liquid crystal layer and the second electrode are disposed in a direction opposite to a projecting direction of the imaging light;
the display component is an Liquid Crystal Display, the Liquid Crystal Display comprises a color filter layer and a second liquid crystal layer, the color filter layer is disposed on a side of the second liquid crystal layer near the display side;
a side of the second electrode away from the first liquid crystal layer is affixed to a side of the color filter layer back from the second liquid crystal layer.

3. The optical assembly of claim 2, wherein the second electrode is affixed to the color filter layer by pasting, vaporizing or sputtering.

4. The optical assembly of claim 1, wherein the refractive component is a liquid crystal lens, the liquid crystal lens comprises a first substrate, a first electrode, a first liquid crystal layer, a second electrode and a second substrate;
the first substrate, the first electrode, the first liquid crystal layer, the second electrode and the second substrate are disposed in a direction opposite to a projecting direction of the imaging light;
the display component comprises a third substrate, a color filter layer and a second liquid crystal layer, the third substrate is disposed near the display side, the color filter layer is disposed between the third substrate and the second liquid crystal layer;
the optical assembly further comprises an adhesive layer, the adhesive layer is disposed between the second substrate and the third substrate, the second substrate is affixed to a side of the third substrate proximate to the display side by the adhesive layer.

5. The optical assembly of claim 4, wherein the adhesive layer comprises an optically transparent adhesive or an optically transparent resin.

6. The optical assembly of claim 4, wherein the display component is one of Liquid Crystal Display, Organic Light-Emitting Diode and Micro light-emitting diode.

7. The optical assembly of claim 2, wherein the liquid crystal lens is one of a twisted nematic type, a coplanar switching type or a vertically oriented type.

8. The optical assembly of claim 4, wherein the liquid crystal lens is one of a twisted nematic, a coplanar switching type or a vertically oriented type.

9. The optical assembly of claim 1, wherein a difference between a dimensions of the display component and a dimensions of the refractive component in a direction perpendicular to a projecting direction of the imaging light is less than or equal to 76.2 mm.

10. The optical assembly of claim 1, wherein the optical assembly further comprises a pancake lens and a linear polarizer;
along a projecting direction of the imaging light, the pancake lens is disposed on a side of the refractive component away from the display component;
the linear polarizer is provided between the pancake lens and the refractive component.

11. A display device comprises an optical assembly, the optical assembly comprising:
a display component having a display side, the display component being capable of projecting imaging light to the display side;
a refractive component provided on the display side and affixed to the display component, the refractive component being configured to adjust a refractive index of the imaging light projected by the display component.

12. The display device of claim 11, wherein the refractive component is a liquid crystal lens, the liquid crystal lens comprises a first substrate, a first electrode, a first liquid crystal layer and a second electrode;
the first substrate, the first electrode, the first liquid crystal layer and the second electrode are disposed in a direction opposite to a projecting direction of the imaging light;
the display component is an Liquid Crystal Display, the Liquid Crystal Display comprises a color filter layer and a second liquid crystal layer, the color filter layer is disposed on a side of the second liquid crystal layer near the display side;
a side of the second electrode away from the first liquid crystal layer is affixed to a side of the color filter layer back from the second liquid crystal layer.

13. The display device of claim 12, wherein the second electrode is affixed to the color filter layer by pasting, vaporizing or sputtering.

14. The display device of claim 11, wherein the refractive component is a liquid crystal lens, the liquid crystal lens comprises a first substrate, a first electrode, a first liquid crystal layer, a second electrode and a second substrate;
the first substrate, the first electrode, the first liquid crystal layer, the second electrode and the second substrate are disposed in a direction opposite to a projecting direction of the imaging light;
the display component comprises a third substrate, a color filter layer and a second liquid crystal layer, the third substrate is disposed near the display side, the color filter layer is disposed between the third substrate and the second liquid crystal layer;
the optical assembly further comprises an adhesive layer, the adhesive layer is disposed between the second substrate and the third substrate, the second substrate is affixed to a side of the third substrate proximate to the display side by the adhesive layer.

15. The display device of claim 14, wherein the adhesive layer comprises an optically transparent adhesive or an optically transparent resin.

16. The display device of claim 14, wherein the display component is one of Liquid Crystal Display, Organic Light-Emitting Diode and Micro light-emitting diode.

17. The display device of claim 12, wherein the liquid crystal lens is one of a twisted nematic type, a coplanar switching type or a vertically oriented type.

18. The display device of claim 14, wherein the liquid crystal lens is one of a twisted nematic, a coplanar switching type or a vertically oriented type.

19. The display device of claim 11, wherein a difference between a dimensions of the display component and a dimensions of the refractive component in a direction perpendicular to a projecting direction of the imaging light is less than or equal to 76.2 mm.

20. The display device of claim 11, wherein the optical assembly further comprises a pancake lens and a linear polarizer;
along a projecting direction of the imaging light, the pancake lens is disposed on a side of the refractive component away from the display component;
the linear polarizer is provided between the pancake lens and the refractive component.
